(19) United States
(12) Patent Application Publication
(10) Pub. No.: US 2024/0253058 A1
(43) Pub. Date: Aug. 1, 2024

(54) METHOD AND SYSTEM FOR PURIFICATION OF OIL

(71) Applicant: SKF MFR TECHNOLOGY AB, Stockholm (SE)

(72) Inventor: Lasse HURNASTI, Huddinge (SE)

(21) Appl. No.: 18/560,495

(22) PCT Filed: Jun. 2, 2021
(86) PCT No.: PCT/EP2021/064800

§ 371 Date: Nov. 13, 2023

(51) Int. Cl. B04B 1/04; B01D 17/02; B01D 17/12; B01D 21/26; B04B 1/20; B04B 11/02; B04B 13/00

(52) U.S. Cl. CPC B04B 1/04; B01D 17/0217; B01D 17/12; B01D 21/262; B04B 11/02; B04B 2001/2083; B04B 2013/006

(57) ABSTRACT

A method and a system for purification of contaminated oil. The method comprising providing contaminated oil into a disc stack centrifugal separator (3). The disc stack centrifugal separator comprises a light phase outlet chamber (33) and/or a heavy phase outlet chamber (31) in which a fluid level can be controlled. Separating the contaminated oil in the disc stack centrifugal separator (3) into a light phase and a heavy phase. Measuring one or more properties in a light phase retrieved from the disc stack centrifugal separator (3), wherein said one or more properties comprise one or more of a density, a viscosity, an amount of heavy phase content and a flow rate of the light phase. Controlling a backpressure provided to a heavy phase outlet (5b) and/or a light phase outlet (5a) of the disc stack centrifugal separator (3) and hereby controlling a fluid level in the heavy phase outlet chamber (31) and/or light phase outlet chamber (33), said controlling being dependent on at least one value of said one or more measured properties.

### TECHNICAL FIELD OF THE INVENTION

The present invention relates to a method and a system for purification of oil.

### BACKGROUND OF THE INVENTION

Purification of oils, such as for example slop oil, waste oil, slurry oil, crude oil, industrial oil, petroleum products or bio-oils is important for the possibility to use/reuse oils and therefore an important factor for the environmental future and the limited nature resources of oils. Purification of slop oil (and waste oil, hereafter only referred to as slop oil) is problematic in many ways. Slop oil can comprise oil, water, particles and emulsion phase. The particles can stabilize the emulsion phase and complicate a purification process. Purification of industrial emulsions comprising water and oil, such as for example cutting fluids is also an important environmental issue.

In slop oil treatment, centrifuge systems are often used for example for separation of oil and water. Slop oils comprise different ingredients, such as different types of oils, water and particles, in different amounts. Hereby a composition of the slop oil will differ between each batch of slop oil to be purified. For example, a density and a viscosity of the oil in the slop oil will differ between different slop oils. Different types of oils may be present in the slop oil in different ratios and the different oils may have different viscosities. Hereby treatment conditions are very different for all batches of slop oil to be purified. This may be the case also for other types of oil to be purified, such as different types of industrial oils. A good purification result will not be achieved when different contaminated oils, such as different batches of slop oils are purified in the same system.

### SUMMARY

An object of the present invention is to provide an improved method and system for purification of contaminated oils.

A further object of the invention is to provide a method and a system which can provide good purification results independently of the composition of contents in the contaminated oil.

This is achieved by a method and a system according to the independent claims.

According to one aspect of the invention a method for purification of contaminated oil is provided. The method comprises the steps of:
providing contaminated oil into a disc stack centrifugal separator, wherein said disc stack centrifugal separator comprises a light phase outlet chamber and/or a heavy phase outlet chamber in which a fluid level can be controlled;
separating the contaminated oil in the disc stack centrifugal separator into a light phase and a heavy phase;
retrieving the separated light phase from a light phase outlet of the disc stack centrifugal separator and retrieving the separated heavy phase from a heavy phase outlet of the disc stack centrifugal separator;
measuring one or more properties in the light phase retrieved from the light phase outlet of the disc stack centrifugal separator, wherein said one or more properties comprise one or more of a density, a viscosity, an amount of heavy phase content and a flow rate of the light phase;
controlling a backpressure provided to the heavy phase outlet and/or the light phase outlet of the disc stack centrifugal separator and hereby controlling a fluid level in the heavy phase outlet chamber and/or light phase outlet chamber, said controlling being dependent on at least one value of said one or more measured properties.

According to another aspect of the invention an oil purification system is provided comprising:
a disc stack centrifugal separator, wherein said disc stack centrifugal separator comprises a light phase outlet chamber and/or a heavy phase outlet chamber in which a fluid level can be controlled;
at least one pressure control device provided to at least one of a light phase outlet of the disc stack centrifugal separator and a heavy phase outlet of the disc stack centrifugal separator, whereby a level of backpressure provided to the light phase outlet and/or the heavy phase outlet can be controlled by controlling the at least one pressure control device;
at least one light phase sensor positioned in the oil purification system for measuring one or more properties in the light phase retrieved from the light phase outlet of the disc stack centrifugal separator, wherein said one or more properties comprises one or more of a density, a viscosity, an amount of heavy phase content and a flow rate of the light phase.

Hereby the system will be specifically adapted for purification of oils with different compositions. This adaptation of the system, i.e. change of a backpressure provided to the light and/or heavy phase outlet from the centrifugal separator, can be performed automatically in dependence of at least one value of the measured one or more properties. Hereby a flexible system is achieved which can be effectively used for purification of different types of contaminated oils. Usually when a disc stack centrifugal separator is used an interface between the oil and water in the disc stack is fixedly set by providing a gravity disc to a heavy phase outlet chamber (also called water paring chamber) and a level ring to a light phase outlet chamber (also called oil paring chamber) of the disc stack centrifugal separator. If the position of the interface between oil and water in the disc stack needs to be adjusted, if for example another type of oil having another density and/or viscosity is to be treated, the gravity disc and/or level ring is changed to another one having another inner diameter whereby the interface between oil and water in the disc stack will be moved. According to the invention a disc stack centrifugal separator is used comprising a heavy phase outlet chamber and/or a light phase outlet chamber in which a fluid level can be controlled. This can be achieved for example by removing a gravity disc or by providing a gravity disc with a comparatively large inner diameter. Hereby the heavy and/or light phase outlet chamber of the disc stack centrifugal separator will allow for a fluid level to be controlled to different positions. By controlling the fluid level in the heavy and/or light phase outlet chamber the position of the interface between oil and water in the disc stack will also be moved. According to the invention the fluid level in the heavy and/or light phase outlet chamber is moved by controlling a back pressure provided to the heavy and/or light phase outlet of the centrifugal separator. This is done in dependence of a value of at least one measured property of light phase retrieved from the centrifugal separator, which can be for example one or more of density, viscosity, heavy phase content in the light phase and flow rate. Hereby the back pressure is controlled in dependence of one or more of these measurements and the position of the interface between oil (light phase) and water (heavy phase) in the disc stack can be controlled in dependence of said measurements whereby the purification system can be adapted easily for different types of oil having different components. The measuring of these properties and the change of backpressure can be provided automatically continuously or at suitable intervals and hereby an automatic oil purification system is achieved which can provide good purification results for different types of for example slop oils comprising different types of oil components.

In one embodiment of the invention said steps of measuring one or more properties and controlling a backpressure are performed continuously or repeatedly at predefined intervals during purification of contaminated oil. Hereby, in some embodiments of the invention the oil purification system further comprising a control system which is provided in communication contact with the at least one light phase sensor and with the at least one pressure control device, wherein said control system is configured to control the at least one pressure control device in dependence of at least one value of the measured one or more properties. In some embodiments of the invention said control system is configured to control the at least one pressure control device such that the backpressure provided to the heavy phase outlet chamber and/or light phase outlet chamber is adjusted continuously or repeatedly at predefined intervals. Hereby the method and the system of the invention will be repeatedly or continuously optimized for different conditions. If for example a composition of different types of oils in the contaminated oil to be purified is changing the system can be automatically adjusted for this immediately. Hereby a flexible and effective method and system for purification of oil is achieved.

In one embodiment of the invention the method further comprises the step of measuring one or more properties in the heavy phase retrieved from the heavy phase outlet of the disc stack centrifugal separator, wherein said one or more properties comprise one or more of a density and a flow rate of the heavy phase. Hereby, in this embodiment the oil purification system further comprises at least one heavy phase sensor positioned in the oil purification system for measuring one or more properties in the heavy phase retrieved from the heavy phase outlet of the disc stack centrifugal separator, wherein said one or more properties comprise one or more of a density and a flow rate of the heavy phase and wherein said heavy phase sensor is provided in communication contact with said control system and wherein said control system is configured to control said at least one pressure control device in dependence of at least one value of the measured one or more properties measured by the light phase sensor and/or the heavy phase sensor.

In one embodiment of the invention said method further comprises controlling a flow rate of the contaminated oil into the disc stack centrifugal separator in dependence of at least one value of said measured one or more properties.

In one embodiment of the invention said step of measuring comprises measuring at least two or three properties in the light phase retrieved from the light phase outlet of the disc stack centrifugal separator, wherein said at least two or three properties comprise two or three or more of a density, a viscosity, an amount of heavy phase content and a flow rate of the light phase, wherein said step of controlling is dependent on at least two or three values of the measured at least two or three properties.

In one embodiment of the invention said step of controlling a backpressure comprises controlling a pressure control device provided in connection with the heavy phase outlet and/or a pressure control device provided in connection with the light phase outlet of the disc stack centrifugal separator.

In one embodiment of the invention the step of controlling a backpressure comprises controlling a backpressure provided to the light phase outlet to decrease and/or a backpressure provided to the heavy phase outlet to increase if a value of a measured density or viscosity of the retrieved light phase is increasing.

In one embodiment of the invention the oil purification system further comprises at least one pressure sensor which is provided in fluid connection with at least one of the light phase outlet or the heavy phase outlet, wherein said at least one pressure sensor is provided in communication contact with said control system and whereby said control system is configured to control said at least one pressure control device further in dependence on a reading from said at least one pressure sensor. Hereby a control of the backpressure can be provided with precision.

In one embodiment of the invention said oil purification system further comprises a contaminated oil tank comprising contaminated oil to be purified, wherein said contaminated oil tank comprises an outlet which is fluidly connected to an inlet of the disc stack centrifugal separator possibly via one or more further oil treatment units.

In one embodiment of the invention said at least one pressure control device is at least one control valve provided to a light phase fluid line connected to the light phase outlet and/or to a heavy phase fluid line connected to the heavy phase outlet.

### BRIEF DESCRIPTION OF THE DRAWINGS

FIG. 1 shows schematically an oil purification system according to one embodiment of the invention.

FIG. 2 is a flow chart of a method according to one embodiment of the invention.

FIG. 3 shows schematically a cross section of a disc stack centrifugal separator.

FIG. 4a shows a cross section of a top portion of a disc stack centrifugal separator comprising a gravity disc according to prior art. FIG. 4b shows a cross section of a top portion of a disc stack centrifugal separator where no gravity disc is provided according to the invention.

FIG. 5 shows schematically a heavy phase outlet chamber or a light phase outlet chamber of a disc stack centrifugal separator in which a fluid level can be controlled according to the invention.

FIG. 6 is a diagram showing grade efficiency for a centrifuge depending on droplet sizes for three different flow rates.

### DETAILED DESCRIPTION OF THE EMBODIMENTS

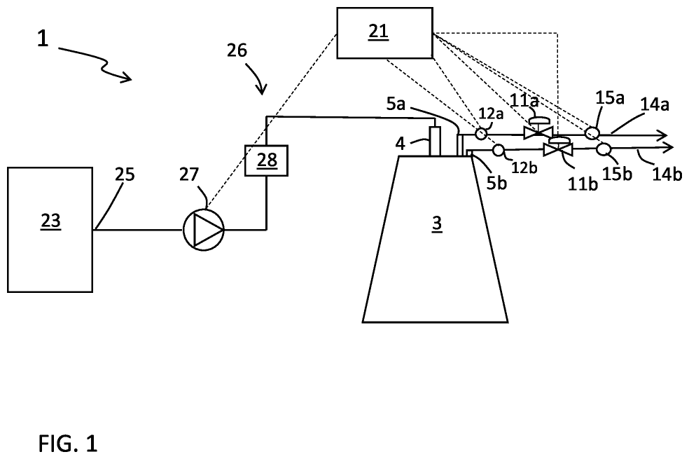

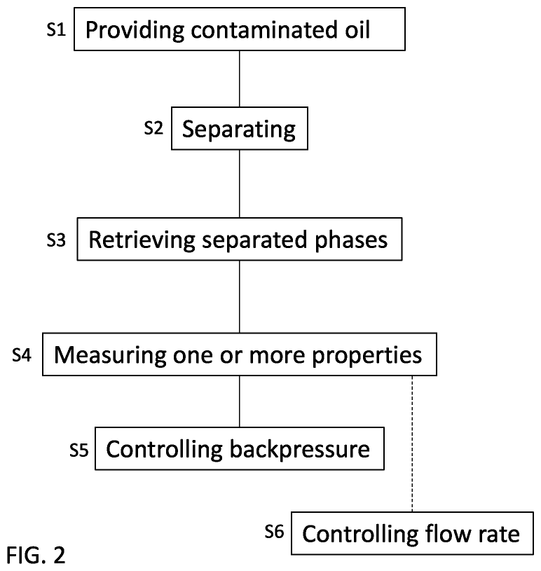

FIG. 1 shows schematically an oil purification system 1 according to one embodiment of the invention. FIG. 2 is a flow chart of a method according to one embodiment of the invention.

The oil purification system 1 comprises a disc stack centrifugal separator 3. The disc stack centrifugal separator 3 is schematically shown in FIG. 1 to comprise an inlet 4 through which contaminated oil to be purified can be provided into the disc stack centrifugal separator 3. In FIG. 1 a contaminated oil tank 23 is also schematically shown comprising an outlet 25 which is fluidly connected by at least one fluid connection 26 to the inlet 4 of the disc stack centrifugal separator 3. A pump 27 is also shown connected in the at least one fluid connection 26 for pumping the contaminated oil from the contaminated oil tank 23 to the inlet 4 of the disc stack centrifugal separator 3. In some embodiments of the invention other oil treatment units 28 can be provided in the at least one fluid connection 26 between the contaminated oil tank 23 and the disc stack centrifugal separator 3. These other oil treatment units 28 are only schematically shown as one unit. The other oil treatment units 28 can for example comprise one or more filters, one or more mixing units, a separation aid adding device, one or more buffer tank, one or more settling tanks or one or more further centrifugal separators.

The disc stack centrifugal separator 3 comprises furthermore a light phase outlet 5a and a heavy phase outlet 5b. The contaminated oil is separated in the disc stack centrifugal separator 3 into a light phase and a heavy phase whereby a light phase will be retrieved from the disc stack centrifugal separator 3 from the light phase outlet 5a and a heavy phase will be retrieved from the disc stack centrifugal separator from the heavy phase outlet 5b after the separation.

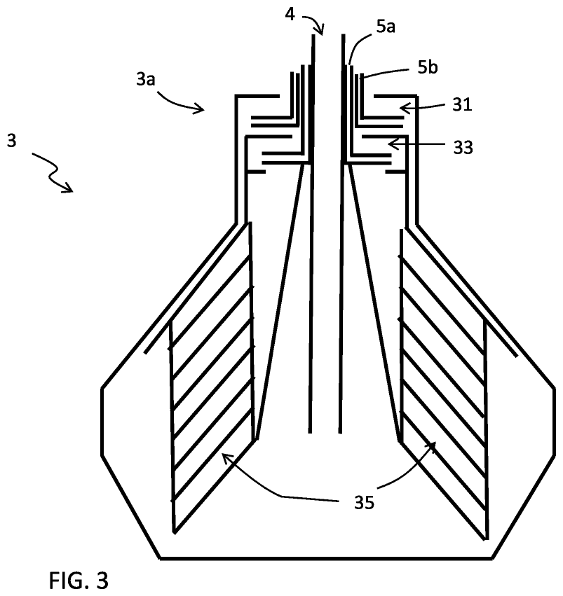

FIG. 3 shows schematically a cross section of a disc stack centrifugal separator 3. This is only a schematic principal view for a disc stack centrifugal separator which can be used for the invention. An inlet 4, a light phase outlet 5a and a heavy phase outlet 5b are schematically shown in FIG. 3. Furthermore, a heavy phase outlet chamber 31 in fluid connection with the heavy phase outlet 5b and a light phase outlet chamber 33 in fluid connection with the light phase outlet 5a are shown in a top part 3a of the centrifugal separator 3. A disc stack 35 is also schematically shown in the disc stack centrifugal separator whereby the heavy and light phases are separated in this disc stack according to what is well known for disc stack centrifugal separators.

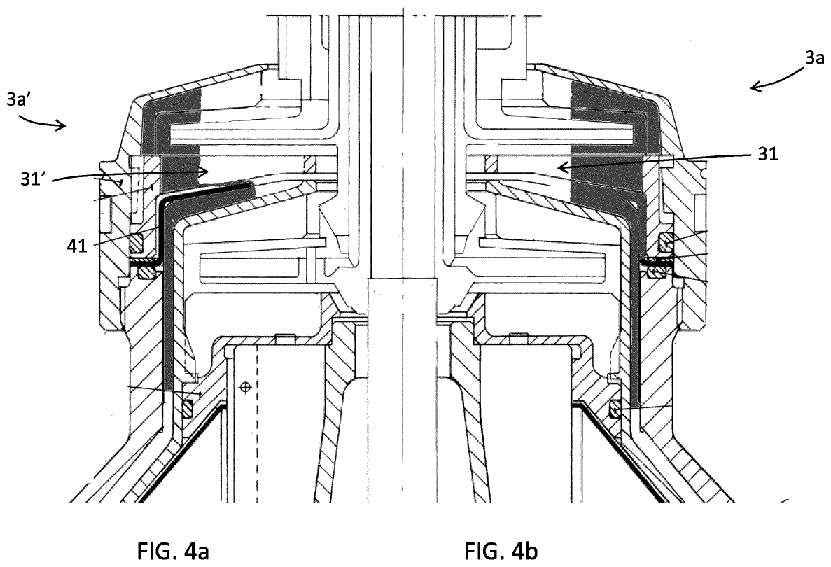

Usually when a disc stack centrifugal separator is used an interface between the oil (light phase) and water (heavy phase) in the disc stack 35 is fixedly set by providing a gravity disc to the heavy phase outlet chamber 31 (also called water paring chamber) and a level ring to the light phase outlet chamber 33 (also called oil paring chamber) of the disc stack centrifugal separator. In FIG. 4a a top part 3a′ of a disc stack centrifugal separator 3′ which is not according to the invention but rather according to prior art is shown. In a heavy phase outlet chamber 31′ of this prior art disc stack centrifugal separator 3′ such a gravity disc 41 is provided. In FIG. 4b a corresponding top part 3a of a disc stack centrifugal separator 3 according to the invention is shown. Here no gravity disc is provided in the heavy phase outlet chamber 31. Alternatively, a gravity disc could be provided in the heavy phase outlet chamber 31 also according to the invention but with a larger inner diameter for allowing a control of the fluid level in the heavy phase outlet chamber 31. Correspondingly a level ring (not shown) is usually provided in the light phase outlet chamber 33′ of a prior art disc stack centrifugal separator 3′ but according to the invention said level ring may be removed. According to the invention a disc stack centrifugal separator 3 is used comprising a heavy phase outlet chamber 31 and/or a light phase outlet chamber 33 in which a fluid level can be controlled. This can be achieved for example by removing a gravity disc and/or a level ring or by providing a gravity disc and/or a level ring with a comparatively large inner diameter. Hereby the heavy and/or light phase outlet chamber 31, 33 of the disc stack centrifugal separator will allow for a fluid level to be controlled to different positions. Hereby it is only necessary to provide one of the heavy phase outlet chamber 31 or the light phase outlet chamber 33 such that a fluid level can be controlled and hereby one of a gravity disc or a level ring could be kept in some embodiments of the invention.

In prior art disc stack centrifugal separators the gravity disc and/or the level ring has to be changed to another size if the position of the interface between light phase and heavy phase in the disc stack needs to be adjusted. This would be necessary if for example another type of oil having another density and/or viscosity should be treated. By changing a gravity disc or level ring to another one with different diameter the interface between light phase and heavy phase in the disc stack will be moved.

According to the invention a fluid level in the heavy phase outlet chamber 31 and/or the light phase outlet chamber 33 can be controlled and by this control the position of the interface between light phase and heavy phase in the disc stack 35 will also be moved. The fluid level can be controlled by providing a heavy phase outlet chamber and/or a light phase outlet chamber with an open inner room, i.e. for example without a limiting gravity disc or level ring. According to the invention the fluid level in the heavy phase outlet chamber 31 and/or light phase outlet chamber 33 is moved by controlling a back pressure provided to the heavy phase outlet 5b and/or the light phase outlet 5a of the centrifugal separator 3.

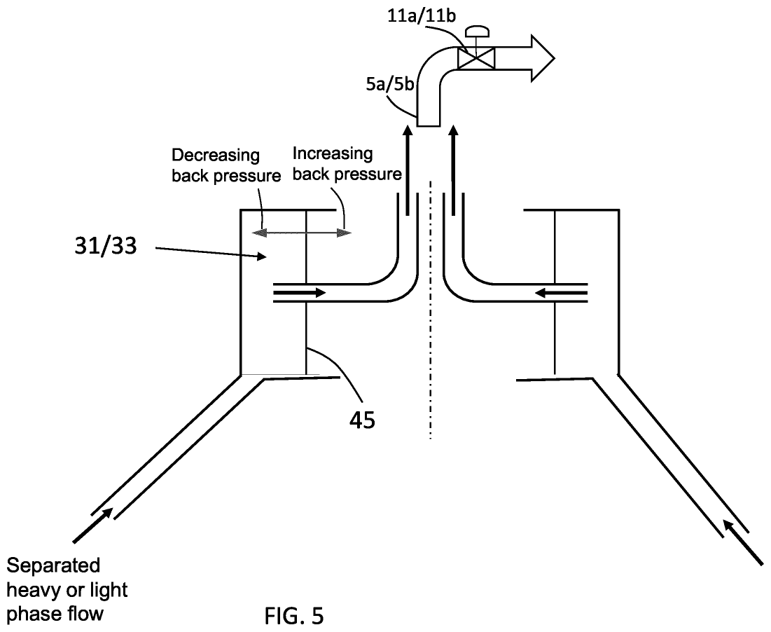

In FIG. 5 it is schematically shown how a fluid level 45 in the heavy phase outlet chamber 31 or the light phase outlet chamber 33 can be moved. The chamber shown in FIG. 5 can be any one of the heavy phase or light phase outlet chamber 31, 33. It is only a schematic view of how the fluid level 45 can move in relation to how the back pressure is controlled from a pressure control device 11a, 11b, for example a control valve 11a, 11b, which according to the invention is provided in fluid connection with one or both of the light phase outlet 5a and the heavy phase outlet 5b. The fluid level 45 will move to the left in FIG. 5 if the back pressure provided to the heavy phase outlet 5b or the light phase outlet 5a decreases and the fluid level 45 will move to the right in FIG. 5 if the back pressure provided to the heavy phase outlet 5b or the light phase outlet 5a increases. A movement of the fluid level 45 will also affect an interface between the heavy phase and the light phase within the disc stack 35 and hereby the position of the interface between the heavy phase and the light phase in the disc stack 35 can be controlled by controlling the pressure control device 11a, 11b. Hereby the separation efficiency can be optimized for different types of contaminated oils. The interface between the heavy phase and the light phase in the disc stack 35 should suitably be positioned somewhere between a position just outside a disc stack outer edge and a middle of distribution holes which are provided in the disc stack for distribution of the incoming feed. With such a location of the interface position the flow will be distributed evenly giving same flow rate between every disc in the disc stack. If the interface position is going too far outside the disc stack edge, oil will be lost into the water outlet. The so-called “water lock” is lost and oil is going out the wrong way unseparated. If the interface position is located from the middle of the distribution holes and inwards this will be acting as a flow restriction since most of the holes will have a water density level were the incoming oil feed is provided. This density difference creates an uneven distribution in the disc stack and consequently poor separability.

According to the invention a light phase outlet chamber 33 and/or a heavy phase outlet chamber 31 in which a fluid level can be controlled is provided in the disc stack centrifugal separator 3. Furthermore at least one pressure control device 11a, 11b is provided in fluid connection with at least one of a light phase outlet 5a of the disc stack centrifugal separator 3 and a heavy phase outlet 5b of the disc stack centrifugal separator 3. The pressure control device 11a, 11b can be for example a control valve 11a, 11b provided to a light phase fluid line 14a connected to the light phase outlet 5a and/or to a heavy phase fluid line 14b connected to the heavy phase outlet 5b. Hereby a level of backpressure provided to the light phase outlet 5a and/or the heavy phase outlet 5b can be controlled by controlling the at least one pressure control device 11a, 11b. Either only one of the heavy phase or light phase outlets 5a, 5b is controlled according to the invention and hereby provided with a pressure control device 11a, 11b or both of the heavy and light phase outlets 5a, 5b can be controlled. However, in order to control the interface position in the disc stack 35 only one of the heavy phase outlet 5b or the light phase outlet 5a has to be controlled by providing a controlled back pressure according to the invention. Hereby also only one of the heavy phase outlet chamber 31 and the light phase outlet chamber 33 needs to be a chamber in which a fluid level can be controlled. In FIG. 1 it is however shown to be control valves 11a, 11b provided in connection with both the light phase outlet 5a and the heavy phase outlet 5b. One of them can therefore be omitted.

Further according to the invention at least one light phase sensor 15a is positioned in the oil purification system 1 for measuring one or more properties in the light phase retrieved from the light phase outlet 5a of the disc stack centrifugal separator 3. Said one or more properties comprises one or more of a density, a viscosity, an amount of heavy phase content and a flow rate of the light phase.

In some embodiments, but not necessarily the oil purification system 1 further comprises at least one heavy phase sensor 15b positioned in the oil purification system 1 for measuring one or more properties in the heavy phase retrieved from the heavy phase outlet 5b of the disc stack centrifugal separator 3. Said one or more properties comprise one or more of a density and a flow rate of the heavy phase.

The oil purification system 1 comprises furthermore a control system 21 which is provided in communication contact with the at least one light phase sensor 15a and with the heavy phase sensor 15b if such a sensor is provided. The control system 21 is further provided in communication contact with the at least one pressure control device 11a, 11b, wherein said pressure control device 11a, 11b can be controlled in dependence of at least one value of the measured one or more properties. The control device 21 is in communication connection with the at least one sensor 15a, 15b and with the at least one pressure control device 11a, 11b, i.e. a wireless or wired connection. The connections with the control system 21 are shown by dotted lines in FIG. 1. Suitably at least one pressure sensor 12a, 12b is provided in fluid connection with at least one of the light phase outlet 5a or the heavy phase outlet 5b. In FIG. 1 a light phase pressure sensor 12a is provided in connection with the light phase outlet 5a. The light phase pressure sensor 12a is here provided in the light phase fluid line 14a connected to the light phase fluid outlet 5a. Correspondingly a heavy phase pressure sensor 12b may be provided in connection with the heavy phase outlet 5b, for example provided in the heavy phase fluid line 14b which is connected to the heavy phase outlet 5b. However, only one of these two pressure sensors 14a, 14b would be needed for controlling a back pressure to only one of the heavy and light phase outlets 5a, 5b. The light phase pressure sensor 12a and/or the heavy phase pressure sensor 12b are also provided in connection with the control system 21 and hereby the control system 21 can control the at least one pressure control device 11a, 11b according to readings from this at least one pressure sensor 12a, 12b.

Said control system 21 may be configured to control the at least one pressure control device 11a, 11b such that the backpressure provided to the heavy phase outlet chamber 31 and/or light phase outlet chamber 33 is adjusted continuously or repeatedly at predefined intervals. Hereby the centrifugal separator 3 can be adopted for different conditions continuously or at repeated intervals. For example if the density or viscosity of the oil is shifting due to different types of oil components this shift is measured by the light phase sensor 15a and the backpressure provided to the heavy phase outlet 5b or the light phase outlet 5a can be controlled by a suitable and corresponding amount such that the fluid level 45 in the heavy phase outlet chamber 31 or the light phase outlet chamber 33 is moved a suitable distance whereby the position of the interface between heavy phase and light phase in the disc stack 35 will be moved a corresponding distance. The correlation between change in backpressure and movement of position of the interface in the disc stack needs to be calculated since it is depending on density differences heavy phase/light phase, viscosity, flow rate and heavy phase content.

The light phase separated in the disc stack centrifugal separator 3 in the oil purification system 1 according to the invention can be oil of different types. The heavy phase can for example be water, water comprising salt, such as brine or water with added mono ethylene glycol (MEG).

In FIG. 2 a flow chart of a method for purification of contaminated oil according to one embodiment of the invention is shown. The method steps are described below:

S1: Providing contaminated oil into a disc stack centrifugal separator 3, wherein said disc stack centrifugal separator 3 comprises a light phase outlet chamber 33 and/or a heavy phase outlet chamber 31 in which a fluid level can be controlled.

S2: Separating the contaminated oil in the disc stack centrifugal separator 3 into a light phase and a heavy phase.

S3: Retrieving the separated light phase from a light phase outlet 5a of the disc stack centrifugal separator 3 and retrieving the separated heavy phase from a heavy phase outlet 5b of the disc stack centrifugal separator 3.

S4: Measuring one or more properties in the light phase retrieved from the light phase outlet 5a of the disc stack centrifugal separator 3, wherein said one or more properties comprise one or more of a density, a viscosity, an amount of heavy phase content and a flow rate of the light phase.

S5: Controlling a backpressure provided to the heavy phase outlet 5b and/or the light phase outlet 5a of the disc stack centrifugal separator 3 and hereby controlling a fluid level in the heavy phase outlet chamber 31 and/or light phase outlet chamber 33 and hereby adjusting an interface between the heavy phase and the light phase in a disc stack part 35 of the disc stack centrifugal separator 3, said controlling being dependent on at least one value of said one or more measured properties.

Said steps of measuring one or more properties, S4, and controlling a backpressure, S5, are performed continuously or repeatedly at predefined intervals during purification of oil.

The method may also comprise the step of measuring one or more properties in the heavy phase retrieved from the heavy phase outlet 5b of the disc stack centrifugal separator 3. However, this is optional. Said one or more properties comprise one or more of a density and a flow rate of the heavy phase. Wherein said step of controlling a backpressure, S5, further can be dependent on at least one value of said one or more properties measured in the heavy phase.

The method can in some embodiments also comprise the step:

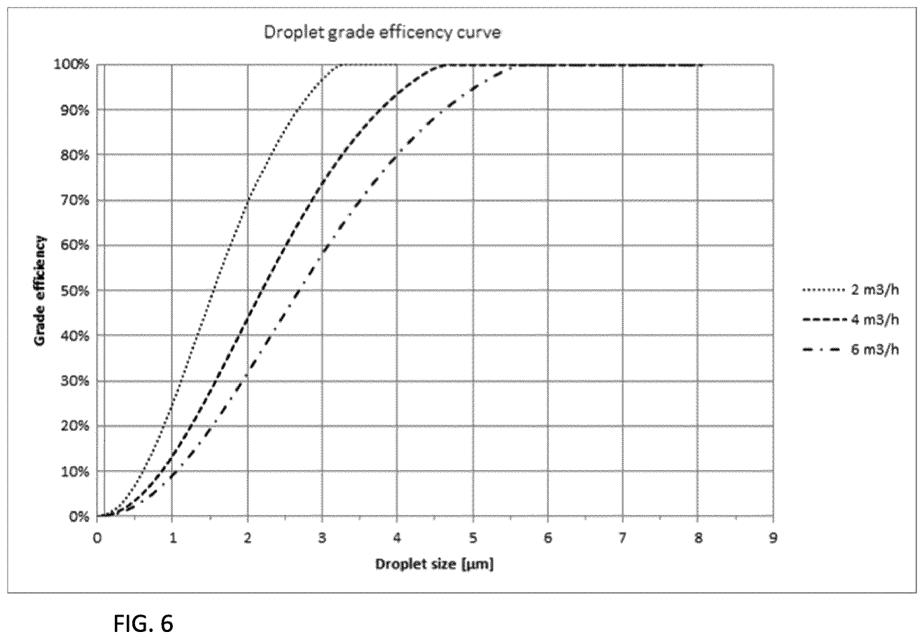

S6: Controlling a flow rate of the contaminated oil into the disc stack centrifugal separator 3 in dependence of at least one value of said measured one or more properties. For example, the pump 27 may be connected to the control system 21 and be controlled in dependence of a measured property. For example, if a level of heavy phase content in the light phase is measured to be above a predefined threshold even though a backpressure provided to the light phase outlet 5a and/or the heavy phase outlet 5b has been corrected accordingly the reason could for example be that there are too small droplets of heavy phase in the light phase. The centrifugal separator 3 is effective for removing droplets above a certain size but will not effectively remove smaller droplets. The droplet sizes which are effectively removed is dependent on the flow rate. With a higher flow rate through the centrifugal separator smaller droplets will not be separated. See the diagram in FIG. 6 for a comparison between different flow rates. At a smaller flow rate the retention time for the fluid in the disc stack 35 of the centrifugal separator 3 will increase and hereby also smaller droplets of heavy phase will be better separated. Hereby, it may be suitable to lower the flow rate through the centrifugal separator if the heavy phase content in the light phase retrieved from the light phase outlet 5a of the centrifugal separator is above a certain threshold. The flow rate can be controlled by controlling the pump 27 which is provided in the oil purification system 1 for pumping contaminated oil into the centrifugal separator 3.

In some embodiments of the invention said step of measuring comprises measuring at least two or three properties in the light phase retrieved from the light phase outlet 5a of the disc stack centrifugal separator 3, wherein said at least two or three properties comprise two or three or more of a density, a viscosity, an amount of heavy phase content and a flow rate of the light phase, wherein said step of controlling is dependent on at least two or three values of the measured at least two or three properties. Hereby a combined assessment of different factors can be used for optimizing the separation efficiency of the centrifugal separator 3.

In some embodiments of the invention the step of controlling a backpressure, S5, comprises controlling a control valve 11b provided to the heavy phase outlet 5b and/or a control valve 11a provided to the light phase outlet 5a of the disc stack centrifugal separator 3.

In some embodiments of the invention the step of controlling a backpressure, S5, comprises controlling a backpressure provided to the light phase outlet 5a to decrease and/or a backpressure provided to the heavy phase outlet 5b to increase if a value of a measured density or viscosity of the retrieved light phase is increasing. A density increase on the light phase will change the hydrostatic balance (position of the light phase/heavy phase interface inside the centrifuge disc stack area) and needs to be compensated by increasing the heavy phase outlet 5b backpressure and/or decreased pressure adjustment on the light phase outlet 5a and a density decrease will be the opposite to this. A viscosity increase will change the internal pressure drop through the disc stack and consequently move the heavy phase/light phase interface and needs to be compensated by increasing the heavy phase outlet backpressure and/or decreased pressure adjustment on the light phase outlet and a viscosity decrease will be the opposite to this. An increased heavy phase content in the incoming slop oil will increase internal pressure drop on the separated heavy phase side. This will move light phase/heavy phase interface inside the centrifuge disc stack area closer to the centre of rotation. This needs to be compensated by decreasing the heavy phase outlet backpressure and/or increased pressure adjustment on the light phase outlet and a decreased heavy phase content in the incoming slop oil will be the opposite to this.

1. A method for purification of contaminated oil, the method comprising the steps of:
providing contaminated oil into a disc stack centrifugal separator, wherein the disc stack centrifugal separator includes a light phase outlet chamber and/or a heavy phase outlet chamber in which a fluid level can be controlled;
separating the contaminated oil in the disc stack centrifugal separator into a light phase and a heavy phase;
retrieving the separated light phase from a light phase outlet of the disc stack centrifugal separator and retrieving the separated heavy phase from a heavy phase outlet of the disc stack centrifugal separator;
measuring one or more properties in the light phase retrieved from the light phase outlet of the disc stack centrifugal separator, wherein the one or more properties include one or more of a density, a viscosity, an amount of heavy phase content and a flow rate of the light phase;
controlling a backpressure provided to the heavy phase outlet and/or the light phase outlet of the disc stack centrifugal separator and so as to control a fluid level in the heavy phase outlet chamber and/or the light phase outlet chamber, the controlling being dependent on at least one value of the one or more measured properties; and
controlling a flow rate of the contaminated oil into the disc stack centrifugal separator depending on at least one value of the one or more measured properties.

2. The method according to claim 1, wherein the steps of measuring one or more properties and controlling a backpressure are performed continuously or repeatedly at predefined intervals during purification of contaminated oil.

3. The method according to claim 1, further comprising a step of measuring one or more properties in the heavy phase retrieved from the heavy phase outlet of the disc stack centrifugal separator, wherein the one or more properties include one or both of a density of the heavy phase and a flow rate of the heavy phase.

4. (canceled)

5. The method according to claim 1, wherein the step of measuring one or more properties includes measuring at least two or three properties in the light phase retrieved from the light phase outlet of the disc stack centrifugal separator, wherein the at least two or three properties include two or three or more of a density, a viscosity, an amount of heavy phase content and a flow rate of the light phase, wherein the step of controlling is dependent on at least two or three values of the measured at least two or three properties.

6. The method according to claim 1, wherein the step of controlling a backpressure includes controlling a pressure control device connected with the heavy phase outlet and/or a pressure control device connected with the light phase outlet of the disc stack centrifugal separator.

7. The method according to claim 1, wherein the step of controlling a backpressure includes decreasing a backpressure provided to the light phase outlet and/or increasing a backpressure provided to the heavy phase outlet if a value of a measured density or viscosity of the retrieved light phase increases.

8. An oil purification system comprising:
a disc stack centrifugal separator including a light phase outlet chamber within which a fluid level can be controlled and/or a heavy phase outlet chamber within which a fluid level can be controlled;
at least one pressure control device provided to at least one of a light phase outlet of the disc stack centrifugal separator and a heavy phase outlet of the disc stack centrifugal separator, whereby a level of backpressure provided to the light phase outlet and/or the heavy phase outlet can be controlled by operating the at least one pressure control device;
at least one light phase sensor positioned in the oil purification system and configured to measure one or more properties in the light phase retrieved from the light phase outlet of the disc stack centrifugal separator, wherein the one or more properties includes one or more of a density, a viscosity, an amount of heavy phase content and a flow rate of the light phase;
a pump for pumping contaminated oil from a contaminated oil tank to an inlet of the disc stack centrifugal separator; and
a control system communicatively connected with the at least one light phase sensor and with the at least one pressure control device, wherein the control system is configured to control the at least one pressure control device depending on at least one value of the one or more measured properties, the control system being connected to the pump and configured to control the pump to control a flow rate of the contaminated oil into the disc stack centrifugal separator depending on at least one value of the one or more measured properties.

9. (canceled)

10. The oil purification system according to claim 8, wherein the control system is configured to control the at least one pressure control device such that the backpressure provided to the heavy phase outlet chamber and/or the light phase outlet chamber is adjusted continuously or repeatedly at predefined intervals.

11. The oil purification system according to claim 8, further comprising at least one heavy phase sensor positioned in the oil purification system and configured to measure one or more properties in the heavy phase retrieved from the heavy phase outlet of the disc stack centrifugal separator, wherein the one or more properties include one or both of a density of the heavy phase and a flow rate of the heavy phase and wherein the heavy phase sensor is communicatively connected with the control system and wherein the control system is configured to control the at least one pressure control device depending on at least one value of the one or more properties measured by the light phase sensor and/or the heavy phase sensor.

12. The oil purification system according to claim 8, further comprising at least one pressure sensor fluidly connected with at least one of the light phase outlet and/or the heavy phase outlet, wherein the at least one pressure sensor is communicatively connected with the control system and whereby the control system is configured to control the at least one pressure control device further depending on a reading from the at least one pressure sensor.

13. (canceled)

14. The oil purification system according to claim 8, wherein the at least one pressure control device includes at least one control valve provided to a light phase fluid line connected to the light phase outlet and/or to a heavy phase fluid line connected to the heavy phase outlet.
